(19) United States
(12) Patent Application Publication
(10) Pub. No.: US 2018/0189609 A1
(43) Pub. Date: Jul. 5, 2018

(54) TRAINING DATA FOR MACHINE-BASED OBJECT RECOGNITION

(71) Applicant: QUALCOMM Incorporated, San Diego, CA (US)

(72) Inventors: Edwin Chongwoo Park, San Diego, CA (US); Victor Chan, Del Mar, CA (US)

(21) Appl. No.: 15/861,620

(22) Filed: Jan. 3, 2018

Related U.S. Application Data
(60) Provisional application No. 62/442,271, filed on Jan. 4, 2017.

(51) Int. Cl. G06K 9/62; G06F 15/18

(52) U.S. Cl. CPC G06K 9/6257; G06K 9/6267; G06F 15/18

(57) ABSTRACT

Systems and methods may enable a user who may not have any experience in machine learning to effectively train new models for use in object recognition applications of a device. Embodiments can include, for example, analyzing training data comprising a set of images to determine a set of metrics indicative of a suitability of the training data in machine-learning training for object recognition, and providing an indication of the set of metrics to a user. Additionally or alternatively, an intermediate model can be used, after a first portion of the machine-learning training is conducted, to determine the effectiveness of a remaining portion of negative samples (images without the object) in the training data or to find other negative samples outside of the training data. Identifying and utilizing effective negative samples in this manner can improve the effectiveness of the training.

### RELATED APPLICATIONS

This application claims the benefit of U.S. Provisional Application No. 62/442,271, filed Jan. 4, 2017, entitled “THIRD PARTY CLOUD TRAINING FOR MACHINE LEARNING”, of which is assigned to the assignee hereof, and incorporated herein in its entirety by reference. Additionally, the present application is related in subject matter to, assigned to the same assignee as, and filed on the same day as U.S. patent application No. UNKNOWN, entitled “GUIDED MACHINE-LEARNING TRAINING USING A THIRD PARTY CLOUD-BASED SYSTEM,” which is also incorporated by reference herein in its entirety.

### BACKGROUND

Among the features that modern electronic devices are able to provide are computer vision (CV) features that enable a device to detect, track, recognize, and/or analyze an object detected by a camera, and/or other sensors. To provide this functionality, machine-learning algorithms can be used to train a “model” that is implemented by the device, enabling the device to recognize an object. However, the training of the model using machine-learning algorithms typically requires an expert knowledge of how to adjust the relevant training parameters to help ensure the training is successful in generating a model, creating a model that meets a particular performance threshold, training the model with particular time/resource requirements, and/or the like. As such, an application developer, device manufacturer, or other entity desiring to provide object recognition functionality may need to share a proprietary set of images (used as training data) with a third-party expert entity to allow the third-party expert entity to train the model.

### SUMMARY

Techniques provided herein are directed to enabling a user who may have limited or no experience in machine learning to effectively train new models for use in object recognition applications of a device. Embodiments can include, for example, analyzing training data comprising a set of images to determine a set of metrics indicative of a suitability of the training data in machine-learning training for object recognition, and providing an indication of the set of metrics to a user. Additionally or alternatively, an intermediate model can be used, after a first portion of the machine-learning training is conducted, to determine the effectiveness of a remaining portion of negative samples (images without the object) in the training data.

An example method of enabling identification of negative samples for machine-learning training for object recognition, according to the description, comprises conducting a first portion of the machine-learning training, where the conducting the first portion of the machine-learning training comprises using a first negative sample set, and creating an intermediate model, based at least in part on the first negative sample set. The method further comprises obtaining a second negative sample set comprising a plurality of negative samples selected using the intermediate model on a set of prospective negative images; and conducting a second portion of the machine-learning training, where the second portion of the machine-learning training comprises using the second negative sample set.

Embodiments of the method may further comprise one or more the following features. The method may further comprise conducting the second portion of the machine-learning training such that a resulting trained model includes the intermediate model. Conducting the first portion of the machine-learning training may also comprise using a positive sample set, and the method may further comprise determining that at an image from the positive sample set was rejected during the first portion of the machine-learning training, and providing an image to the intermediate model to determine whether to include the image in the second negative sample set. The method may further comprise providing the image to a user, and receiving user input indicating that at the image is a negative sample. The method may further comprise receiving, at a server, a user input indicative of a type of object for object recognition; and sending, from the server, a plurality of images based on the user input. Obtaining the set of prospective negative images may comprise: receiving images uploaded by a user, receiving images from a location on the Internet specified by a user, receiving images from a video file, or receiving images from a live video feed, or any combination thereof. Obtaining the second negative sample set comprises receiving, at a server via a data connection, the set of prospective negative images. The method may further comprise obtaining a trained model based, at least in part, on the first portion and the second portion of the machine-learning training, providing an indication of an ability of the trained model to recognize a type of object, subsequent to providing the indication, receiving a user input indicative of an acceptance of the trained model, and providing the trained model to the user. Providing the indication of the ability of the trained model to recognize the type of object may comprise using the trained model to detect the type of object in an image. Providing the indication of the ability of the trained model to recognize the type of object may comprise providing the user with a test model based on the trained model and configured to expire after a certain period of time. Providing the indication of the ability of the trained model to recognize the type of object may comprise providing the user with a test model based on the trained model and having reduced functionality compared with the trained model. Providing the trained model to the user may comprise transmitting the trained model from a server to a user device. Providing the trained model to the user may be responsive to receipt of payment from the user or receipt of an agreement to an obligation of payment from the user.

An example computer, according to the description, comprises a memory and a processing unit communicatively coupled with the memory. The processing unit is configured to cause the computer to conduct a first portion of machine-learning training, wherein conducting the first portion of the machine-learning training comprises using a first negative sample set, and create an intermediate model, based at least in part on the first negative sample set. The processing unit is further configured to cause the computer to obtain a second negative sample set comprising a plurality of negative samples selected using the intermediate model on a set of prospective negative images; and conduct a second portion of the machine-learning training, wherein the second portion of the machine-learning training comprises using the second negative sample set.

Embodiments of the computer may comprise one or more of the following features. The processing unit may be further configured to cause the computer to conduct the second portion of the machine-learning training such that a resulting trained model includes the intermediate model. The processing unit may be further configured to cause the computer to conduct the first portion of the machine-learning training by using a positive sample set, determine that at an image from the positive sample set was rejected during the first portion of the machine-learning training, and provide an image to the intermediate model to determine whether to include the image in the second negative sample set. The processing unit may be further configured to cause the computer to provide the image to a user, and receive user input indicating that at the image is a negative sample. The processing unit may be further configured to cause the computer to receive a user input indicative of a type of object for object recognition; and send a plurality of images based on the user input. The processing unit may be configured to cause the computer to obtain the set of prospective negative images by receiving images uploaded by a user, receiving images from a location on the Internet specified by a user, receiving images from a video file, or receiving images from a live video feed, or any combination thereof. The processing unit may be configured to cause the computer to obtain the second negative sample set by receiving, at a server via a data connection, the set of prospective negative images. The processing unit may be further configured to cause the computer to obtain a trained model based, at least in part, on the first portion and the second portion of the machine-learning training, provide an indication of an ability of the trained model to recognize a type of object, receive, subsequent to providing the indication, a user input indicative of an acceptance of the trained model, and provide the trained model to the user. The processing unit may be configured to cause the computer to provide the indication of the ability of the trained model to recognize the type of object by using the trained model to detect the type of object in an image. The processing unit may be configured to cause the computer to provide the indication of the ability of the trained model to recognize the type of object by providing the user with a test model based on the trained model and configured to expire after a certain period of time. The processing unit may be configured to cause the computer to provide the indication of the ability of the trained model to recognize the type of object by providing the user with a test model based on the trained model and having reduced functionality compared with the trained model. The processing unit may be configured to cause the computer to provide the trained model to the user by transmitting the trained model from a server to a user device. The processing unit may be configured to cause the computer to provide the trained model to the user in response to receipt of payment from the user or receipt of an agreement to an obligation of payment from the user.

An example system, according to the description, comprises means for conducting a first portion of machine-learning training, wherein the conducting the first portion of the machine-learning training comprises using a first negative sample set, and means for creating an intermediate model, based at least in part on the first negative sample set. The system further comprises means for obtaining a second negative sample set comprising a plurality of negative samples selected using the intermediate model on a set of prospective negative images, and means for conducting a second portion of the machine-learning training, wherein the second portion of the machine-learning training comprises using the second negative sample set.

Embodiments of the system may further comprise one or more of the following features. The system may further comprise means for conducting the second portion of the machine-learning training such that a resulting trained model includes the intermediate model. The system may further comprise means for receiving a user input indicative of a type of object for object recognition, and means for sending a plurality of images based on the user input.

An example non-transitory computer-readable medium, according to the description, has instructions embedded thereon for enabling identification of negative samples for machine-learning training for object recognition. The instructions, when executed by one or more computer systems, cause the one or more computer systems to conduct a first portion of the machine-learning training, wherein conducting the first portion of the machine-learning training comprises using a first negative sample set, create an intermediate model, based at least in part on the first negative sample set, obtain a second negative sample set comprising a plurality of negative samples selected using the intermediate model on a set of prospective negative images, and conduct a second portion of the machine-learning training, wherein the second portion of the machine-learning training comprises using the second negative sample set.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is an illustration of an example setup in which a user may be interacting with a device that utilizes computer vision (CV) features.

FIG. 2 is a block diagram of a system capable of performing the machine learning techniques described herein, according to an embodiment.

FIG. 3 is a data flow diagram illustrating how machine learning techniques may be utilized among certain components in the system of FIG. 2, according to some embodiments.

FIG. 4 is a process flow diagram illustrating a method of performing an initial analysis for machine-learning training, according to an embodiment.

FIG. 5 is a process flow diagram illustrating a method of enabling the identification of negative samples for machine-learning training for object recognition, according to an embodiment.

FIG. 6 is a process flow diagram illustrating a method of providing a trained model, according to an embodiment.

FIG. 7 is a block diagram of a computer system.

### DETAILED DESCRIPTION

Several illustrative embodiments will now be described with respect to the accompanying drawings, which form a part hereof. The ensuing description provides embodiment(s) only, and is not intended to limit the scope, applicability or configuration of the disclosure. Rather, the ensuing description of the embodiment(s) will provide those skilled in the art with an enabling description for implementing an embodiment. It is understood that various changes may be made in the function and arrangement of elements without departing from the spirit and scope of this disclosure.

Modern technology has progressed to the point where computer processing can be executed by any of a variety of devices (e.g., mobile phones, thermostats, security devices, appliances, etc.) to perform any of a variety of functions using software and/or hardware components of the devices. Such devices can include stand-alone devices and/or devices that may be communicatively coupled with other devices, including devices in the vast network comprising the Internet of things (IoT). Among the features that these devices are able to provide are computer vision (CV) features. These features enable a device to detect, track, recognize, and/or analyze an object detected by a camera (or other optical sensor) embedded in and/or otherwise communicatively coupled with the device.

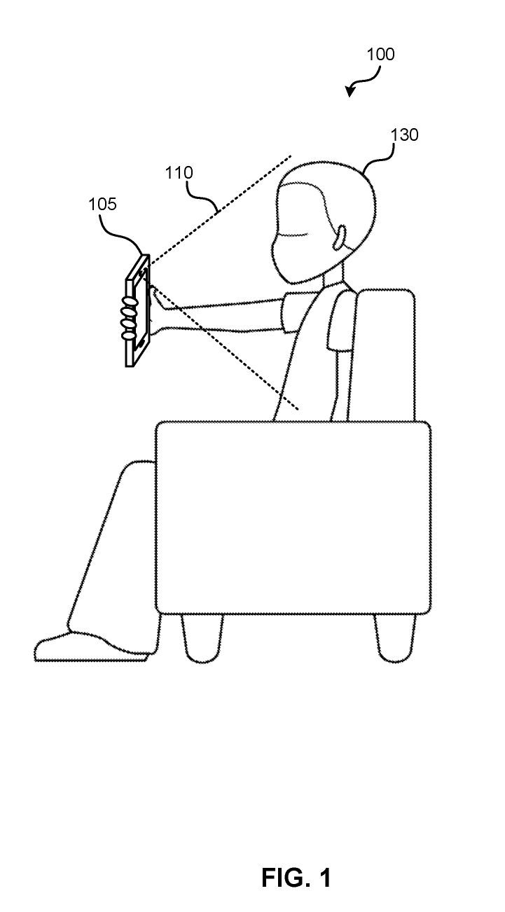

FIG. 1 illustrates an example setup 100 in which a user 130 may be interacting with a device 105 that utilizes CV features. (It will be understood, however, that embodiments are not limited to the illustrated example. A variety of different devices can provide similar functionality in a variety of different applications.) Here, the user 130 may interact with a device 105, having a camera embedded therein. CV functionality provided by the device 105 enables the device 105 to detect, track, recognize, and/or analyze an object (such as the user 130) within the field of view 110 of the device's camera. In some embodiments, the device 105 may perform object detection using the low-level hardware and/or software (e.g., firmware) of the device 105, and provide an indication of the object detection to an operating system and/or application to provide additional functionality based on the object detection (e.g., unlocking a user interface of the device, causing the device to capture an image, etc.). Additional detail regarding CV features and the hardware and/or software that may be used to execute them in a device can be found, for example, in U.S. patent application Ser. No. 14/866,549 entitled “LOW-POWER ALWAYS-ON FACE DETECTION, TRACKING, RECOGNITION AND/OR ANALYSIS USING EVENTS-BASED VISION SENSOR,” which is hereby incorporated by reference in its entirety herein for all purposes.

Traditionally, however, the ability to program the hardware and/or software of a device (such as the device 105 of FIG. 1) has been limited to experts. More particularly, object recognition has traditionally involved using machine-learning algorithms to train a “model” to recognize a type of object by processing a set of images comprising positive input samples (or “positives,” comprising images of a sample of the object type) and negative input samples (or “negatives,” comprising images without an object of the object type). The trained model can then be implemented on the device (in hardware and/or software) to perform object recognition in CV applications. (As used herein, the term “model” can comprise programming that goes into a classifier, such as a cascade classifier, to recognize the presence or absence of an object in an image.) Furthermore, as used herein, the phrase “object recognition” can include recognizing, for example, a human face as compared to any other object, a human hand as compared to any other object, or a human form (entire body, or upper or lower parts of a human body) as compared to any other object, or whole or portions of animals (e.g., dogs, cats, etc.) as compared to any other object, etc. However, “object recognition” may also include recognizing, for example, a human hand in a particular pose or sequence of poses. In such an implementation, “object recognition” can allow for gesture recognition. Furthermore, as used herein, the term “object recognition” refers not only to the identification of a specific instantiation in a class or type of objects, but also the identification of any instance in a class of objects (also known as object “detection”). But the training of the model using machine-learning algorithms typically requires an expert knowledge of how to adjust the relevant parameters to help ensure the training is successful. For example, trainings may not converge to a solution or may be subject to overfit or underfit due to a lack of positives, a lack of negatives, a lack of diversity in positives, and incorrect order of training samples, excessive training stages and/or similar issues. These issues are closely tied to the input images, so the training of the model, the control of the input images, and the implementation of the model are traditionally done by one or more expert entities.

Techniques provided herein address these and other issues by enabling a user who may not have any experience in machine learning to effectively train new objects for use in object recognition applications of a device. Accordingly, these embodiments may allow a user to use a set of images for training (which the user may value as being particularly useful in training the model and may therefore want to protect it as proprietary and confidential) without having to disclose the images to an expert third-party for training the model.

It can be noted that, although embodiments described herein describe the use of images for training a model, embodiments are not so limited. As a person of ordinary skill in the art will appreciate, the techniques described herein are not necessarily limited to the visual modality. A model can be trained using sound, heat, and/or other modalities. As such, embodiments may utilize samples (both positive and negative) of the modality in which the model is being trained (e.g., non-image samples). A person of ordinary skill in the art will appreciate the various alterations to the embodiments explicitly described herein necessary to accommodate model training in such different modalities and the different types of sensors (e.g., audio, thermal, etc.) that can be used in model implementation.

As used herein, the term “user” can refer to a manufacturer of the device (or employee thereof), a software developer of an application executed by the device, an end user of the device, and the like. In some embodiments, for example, a manufacturer of the device may want to perform object detection by the device (e.g., the detection of a face) and may therefore want to program image processing (or other) hardware to implement a model trained to detect the desired type of object. The user may not, however, have expertise in machine-learning training.

According to the techniques provided herein, a user may perform the machine-learning training in the “cloud” (one or more computing devices, such as servers, which may be remote from the user and/or a user device) by interfacing with a server via accessing a website or executing an application on a local device (e.g., a computer, tablet, or similar device local to the user) that enables the local device to communicate with the server. The user can then (e.g. via a user interface) be guided through a process in which the server collects information for training the model from the user. (That said, in some embodiments, the functionality performed by the server as described below may additionally or alternatively be performed by the local device and/or a plurality of servers.) It can be further noted that a cloud may be wholly or partially operated by a third party (e.g., neither the entity training a model nor the entity (expert) providing the model training service).

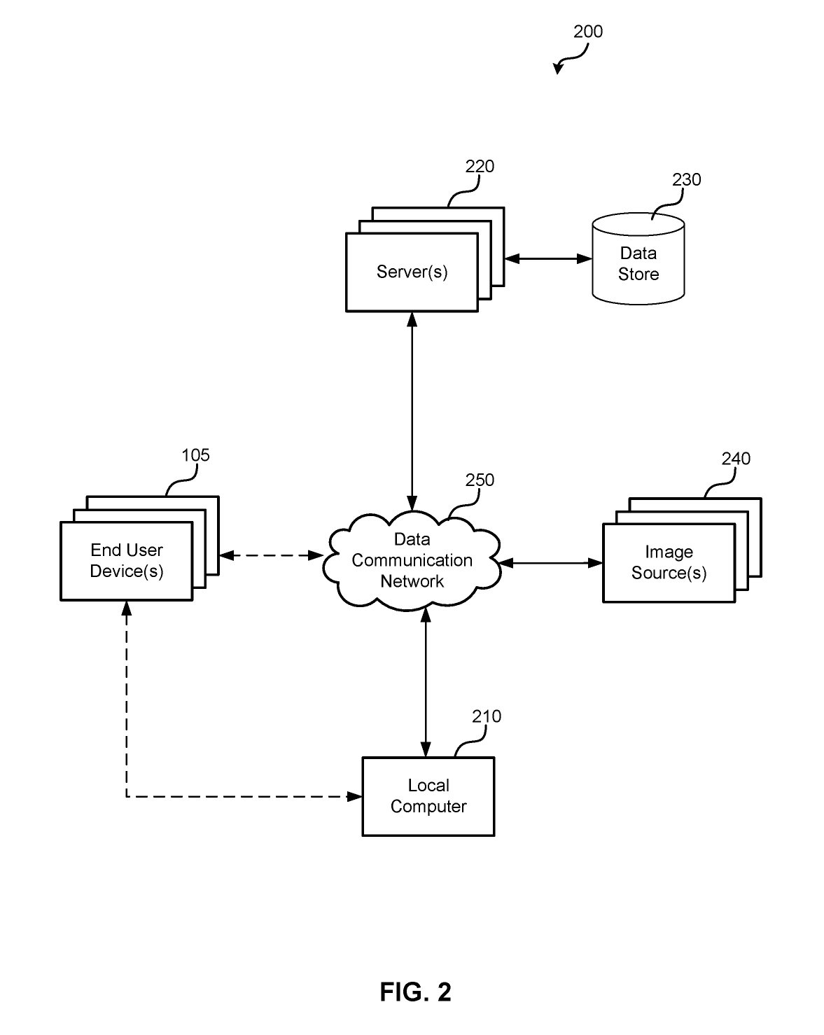

FIG. 2 is a block diagram of a system 200 capable of performing the machine learning techniques described herein, according to an embodiment. Here, the system comprises a local computer 210, one or more servers 220 accessing data store 230, one or more image sources 240, and one or more end user devices 105, connected via a data communication network 250 as illustrated. Double arrows indicate communication between components, and dashed double arrows indicate optional alternatives. As described below, different embodiments may utilize components in different ways, any or all of which may be used in accordance with desired functionality. Alternative embodiments may comprise variations in which components are combined, omitted, rearrange, and/or otherwise altered. In some embodiments, for example, the image source(s) 240 may not be utilized.

As noted above, the techniques described herein can be implemented using the local computer 210. Here, a user (e.g., a manufacturer or servicer of the end-user device(s) 105) can use the local computer 210 to execute a local application and/or log onto a website (e.g., hosted by server(s) 220) to train a model to perform CV functionality using a set of training data comprising a plurality of images. In some embodiments, the training can be performed on the servers 220 and the user can use the local computer 210 to provide the server(s) 220 with the training set. Depending on desired functionality, the training set can be uploaded from the local computer 210 and/or retrieved by the server(s) 220 from the image source(s) 240. For example, in some embodiments, the user can use the local computer 210 to access a website having a graphical user interface enabling the user to input one or more Uniform Resource Locators (URLs) of images hosted by the image source(s) 240 and/or one or more locations on the local computer 210 where images are stored. Once obtained by the server(s) 220, the training data can be stored in data store 230 (e.g., a database) accessible to the server(s) 220 and used during model training. (It can be noted that, although the data 230 is illustrated in FIG. 2 as being local to the server(s) 220, alternative embodiments may have additional or alternative data store 230 accessible by the server(s) 220 via the data communication network 250. In other words, the data store 230 (and other resources such as the source(s) 240) may be accessible to the server(s) 220 via the data communication network 250, which may comprise the Internet, as noted below. Thus, the server(s) 220 may make use of various Internet resources.)

The servers 220 can use the training data to train in machine learning model in accordance with any of a variety of techniques, depending on the type of model desired. A model may comprise, for example, a linear classifier, quadratic classifier, cascade classifier, neural network, decision tree, and/or other type of algorithm or meta-algorithm capable of machine learning. When training is completed, the model can be provided to the local computer 210 or directly to the end user device(s) 105. If provided to the local computer 210, the local computer 210 can then provide the model to the end user device(s) 105 directly or indirectly, as illustrated.

As previously noted, the end user device(s) 105 can implement the model in hardware, and/or software, depending on desired functionality. As such, the end user device(s) 105 may be preprogrammed and/or hardwired to implement the model during manufacture. In embodiments in which the end user device(s) 105 may implement the model in software and/or programmable logic that can be altered after manufacture and/or initial use by the end user(s), the local computer 210 (or other system associated therewith, such as a end user device maintenance system (not illustrated)) can provide the model to the end user device(s) 105 via the data communication network 250 (e.g., by means of a firmware or similar system update).

The data communication network 250 can comprise one or more networks capable of enabling communication between the components of the system 200 as described herein. This includes, for example, one or more private and/or public networks, such as the Internet, which may implement any of a variety of wired and/or wireless technologies for data communication. Moreover, depending on desired functionality, data may be encrypted, to help ensure secure communications were desired.

The system 200 may be able to accommodate any of a variety of types of image sources, depending on desired functionality. As such, in some embodiments, the image source(s) 240 may comprise still images, video files, live video feed, and/or other types of image sources. Videos may be treated as a series of images. A person of ordinary skill in the art will appreciate that other types of sources (e.g., sound) may be utilized in embodiments where a model is being trained using training data other than images.

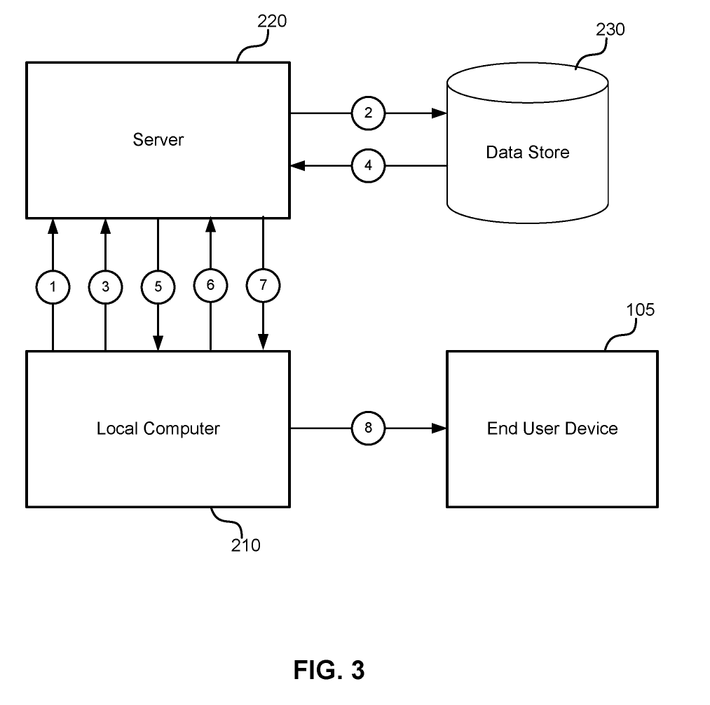

FIG. 3 is a data flow diagram used to help illustrate how machine learning techniques may be utilized among certain components in the system 200, according to some embodiments. For simplicity, architecture illustrated in FIG. 3 illustrates only a subset of the architecture illustrated in FIG. 2 (including only one server 220 and one end user device 105). However, it will be understood that the functionality illustrated in FIG. 3 may be implemented by the system 200 of FIG. 2 and similar systems. Arrows illustrate various functions, in an ordered sequence (referred to herein as Functions 1-8), illustrating the flow of data according to the illustrated embodiments.

For example, at Function 1, data for the conducting the machine learning training is provided by the local computer 210 to the server 220. This data can include, for example, initial settings (parameters) for the training, a location (e.g., URL) of the training data, and/or the training data itself. Providing this information may be facilitated via a graphical user interface, which may be provided by an application executed by the local computer 210, a website accessed via the local computer 210, and the like. At Function 2, the server 220 may store the training data in the data store 230.

As discussed in further detail below, some embodiments may include an initial analysis of one or more features of the training data to determine the effectiveness of the training data for conducting the desired training of the model. In such embodiments, the local computer 210 may, at Function 3, provide a command or other indication to the server 220 to conduct this initial analysis. (In other embodiments, the analysis may be done automatically, in which case a separate command from the local computer 210 may not be used.) To conduct the analysis, the server 220 may retrieve the training data from the data store 230, at Function 4. After the server 220 completes the analysis, the server 220 may provide the results of the analysis to the local computer 210, at Function 5.

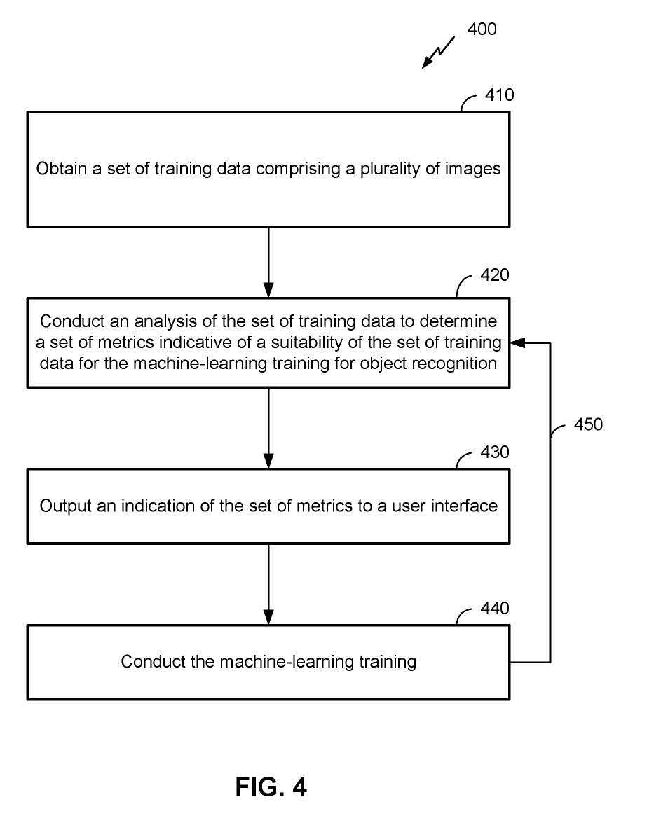

The process can then continue at Function 6, where the local computer 210 provides the server 220 with the command or other indication to begin the training. Here, the local computer 210 may include some additional parameter settings and/or training data. In response to the results of the initial analysis of Functions 3-5. The local computer 210 can, for example, provide the user with the results of the initial analysis, along with a graphical user interface for adjusting settings and/or providing additional/alternative training data. If desired, Functions 3-5 may be repeated for any new training data provided by the user. Additional details regarding this initial analysis of the training data are provided herein below, in reference to FIG. 4.

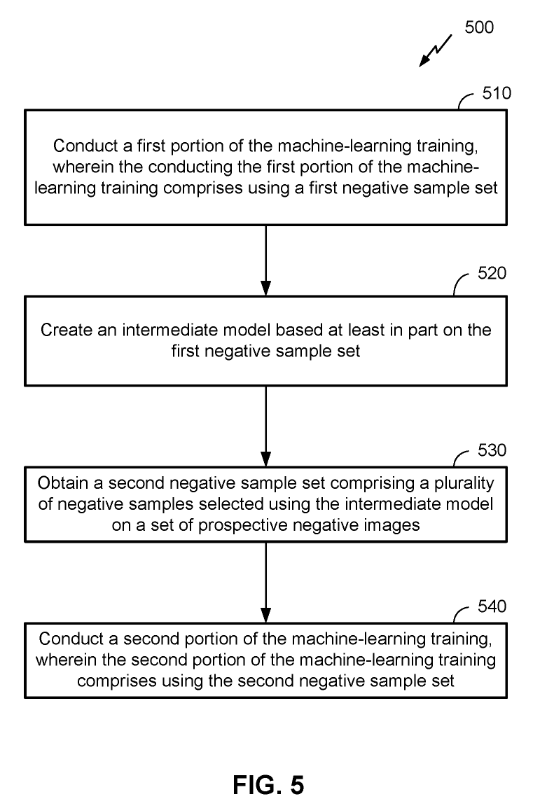

Once this server 220 receives the command of Function 6 to conduct the training, the server 220 can then proceed with the training. Training may vary, depending on the type of model being trained, and may involve multiple stages. In some embodiments, the server 220 may add images to and/or remove images from this training data (which may involve interacting with the data store 230 and/or other components). As described herein below with regard to FIG. 5, for example, embodiments may utilize an intermediate model to determine the effectiveness of training data during the course of training.

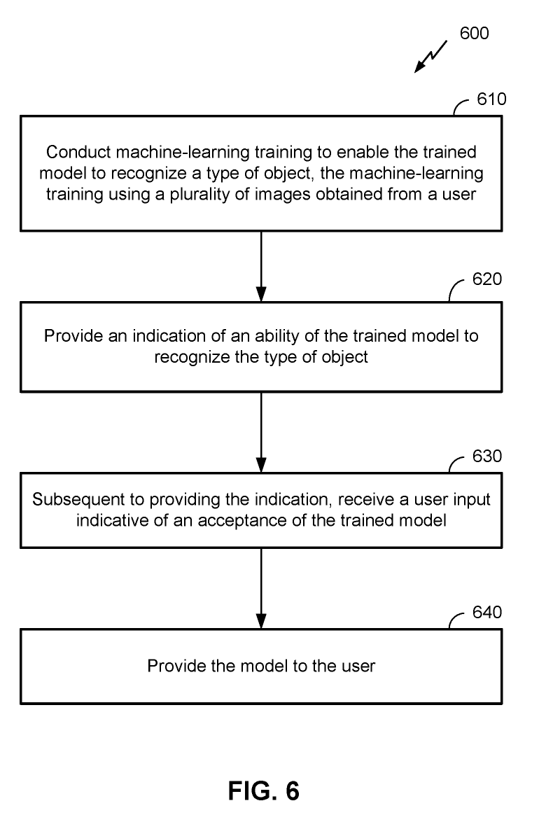

Once training is complete, the model can then be provided to the local computer 210, at Function 7. As described herein below with regard to FIG. 6, in embodiments in which the user of the local computer 210 desires to purchase a trained model, functionality may include enabling the user to determine the effectiveness of the trained model prior to purchase, and prior to the delivery of the trained model.

The local computer 210 can then provide the model to the end user device 105 at Function 8. As discussed above, this functionality may comprise, pre-programming and/or hardwiring into the user device 105 during manufacture and/or communicating the model to the end user device 105 after manufacture (e.g., via a system update).

As previously mentioned, the user may provide a set of training data (a plurality of images) for training the model. These images (also referred to herein as “samples” or “image samples”), can include a plurality of positives and negatives, each may be identified as such to help the model determine, during training, which images contain the object and which images do not.

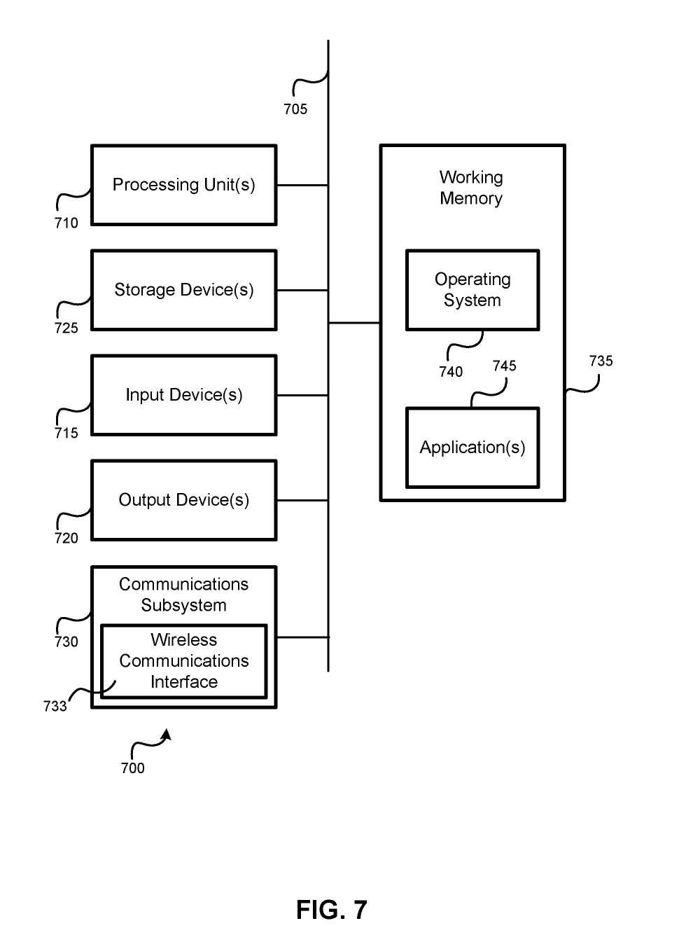

According to some embodiments, the local computer and/or server may perform an initial or first analysis of the set of training data to help determine a (first) set of one or more metrics that indicate how effective the set of training data may be in training a model for object detection. FIG. 4 is a process flow diagram 400 illustrating a method of performing this initial analysis, according to an embodiment. As such, the functions illustrated in the blocks of FIG. 4 may be performed by a local computer 210 and/or remote server(s) 220, depending on desired functionality. Means for performing one or more of the blocks illustrated in FIG. 4 may include hardware and/or software components of a computer, such as the computer 700 of FIG. 7, which may function as a server remote from a local device of a user.

At block 410, a set of training data comprising a plurality of images is obtained. These images may be obtained, for example, from a user that uploads the set of training data to the server from the local device (e.g., local computer 210 of FIGS. 2 and 3), such that, responsive to input received from the user, the local device initiates transfer of the training data to the server and the server receives the training data from the local device. Additionally or alternatively, as noted above, a user may provide a URL or other pointer through a user interface indicating the location of a file or folder (e.g., on a hard drive or other storage medium, on the Internet, etc.) having the set of training data for the server to obtain and analyze. In some embodiments, the universal resource locator (URL) or other pointer may be included in a file, such as an eXtensible Markup Language (XML) file.

At block 420, an analysis of the set of training data is conducted to determine a set of metrics indicative of a suitability of the set of training data for the machine-learning training for object recognition. Block 420 may be performed a first time before any machine-learning training is conducted at block 440, and hence the set of metrics can be a first set of metrics indicative of the suitability of the set of training data for the machine-learning training. Alternatively, as indicated by recursive arrow 450, block 420 may be performed a subsequent time after some machine-learning training at block 440 is conducted, and hence the set of metrics can be a subsequent set of metrics indicative of the suitability of the set of training data for the machine-learning training where the subsequent set of metrics can be, for ease of discussion, referred to as a second set of metrics that are determined at some point after some machine-learning training in block 440 is conducted.

The set of metrics (whether the first set of metrics or the second set of metrics) indicative of the suitability of the set of training data can vary, depending on desired functionality. For example, it has been found that machine-learning training for object detection can be improved when images of the object to be detected are taken from multiple different perspectives. One metric indicative of a perspective of an image that a camera captures of a scene is a pose (where a pose can include both position and orientation of an object) of one or more objects within the image, for example the object to be detected once the machine-training is complete. For example, even if two different images of a scene are capturing the same exact scene, but the position, perspective, and/or orientation of the camera relative to the object to be detected changes between the two images, this diversity in object pose can improve the machine-learning training. As such, one metric that can be included in the set of metrics includes a measure of object pose diversity in the set of training data. Similarly, even if two different images of a scene are capturing the same exact scene, but the exposure and/or amount of light and/or the brightness of the two images differs between the two images, this diversity in image brightness improve the machine-learning training. As such, one metric that can be included in the set of metrics includes a measure of image brightness diversity in the set of training data. In another example, where the object to be detected is a face, a statistic such as the width of the eye relative to the size or the width of the face, could be used as a metric to determine whether a training set is diverse enough to begin and/or continue machine-learning training. As such, one metric that can be included in the set of metrics includes an object-to-be-detected component statistic. Additionally or alternatively, embodiments may examine CV features computed from images included in the training data such as, local binary pattern (LBP), patch symmetric LBP (PSLBP), transition Local Binary Patterns (tLBP), spatial frequencies (e.g., as determined, using Fast Fourier Transform (FFT)), and/or other types of CV features. As such, corresponding metrics indicative of the suitability of the set of training data may comprise patterns, distributions, or other characterizations of these features across the set of training data, which may be indicative of the diversity of the set of training data for purposes of model training. Such metrics may comprise, for example, an LBP feature distribution (including LBP, PSLBP, and/or tLBP), a spatial frequency (FFT) distribution, a convolution distribution, and the like. Hence the set of metrics can include any combination of one or more metrics, including those discussed above or elsewhere herein.

Additionally, in some sets of training data annotation consistency may be problematic. Annotations in training data can comprise metadata for each image indicating, for example, whether an object is included in the image and/or a bounding box (or other indication) of where the object is located within the image. But the consistency of such annotations across all images of a set of training data may vary. For example, a bounding box around an object in a first image may define relatively tight boundaries around the image, whereas a bounding box around an object in a second image may define relatively loose boundaries that include not only the object, but a portion of the object's surroundings. Such inconsistencies within a set of training data can result in inefficient training of a model. As such, some embodiments may, in addition or as an alternative to other metrics indicative of a suitability of the set of training data for model training, include a metric of annotation consistency.

At block 430, method 400 includes outputting an indication of the set of metrics to a user interface to give the user an idea of whether the set of training data may result in the successful training of the model and/or a suggested course of action for the user to take. For example, the analysis of the set of training data may result in a determination that the features of the positives are too similar to one another (e.g. above a certain threshold of similarity) and that the training data therefore lacks in diversity as measured by one or more metrics. Therefore, the set of metrics may include an indication that there is a lack of diversity in positives and may further suggest that the user provide additional positives to the training. According to some embodiments, this may comprise providing a “score” (or value) of the suitability of the training data, where the score is based on the underlying set of metrics. (Where the underlying set of metrics includes a plurality of metrics, metrics may be weighted differently, depending on desired functionality.) Other embodiments may provide a binary output, describing, for example the set of training data as being “good” or “bad” (or the equivalent) based on whether the set of metrics exceeded individual metrics or (optionally, where multiple metrics are used) a combined metric. Additionally or alternatively, qualitative score may be used such as a five-point scale (e.g., ranging from “excellent” to “bad”) or other qualitative indicator (e.g., recommend, . . . , not recommend).

The analysis conducted at block 420 may comprise manipulating the images of the set of training data to identify certain features, which may be reflected in this score. For example, manipulations can include superimposing an image onto a background (white, black, green, etc.), adjusting lighting levels and adding distortions (e.g., using the lens model, the sensor model, adding noise, stretching, and/or compressing images, etc.), moving (transposing) pixels, flipping, rotating, offsetting and inverting images, and the like. (In some embodiments, these manipulated images can also be used in the subsequent training of the model to increase the number of images (e.g., positive samples) in the set of training data.) The set of testing data may then be scored, at least in part, based on features that are present (or absent) in the various images and manipulations, and an indication of the suitability of the training data, including the score may be output to a user at block 430 using a user interface. In some embodiments, for example, the analysis may result in a diversity score from 0 to 100. The user may then decide how to proceed (e.g., cancel the process, provide more or alternative images, proceed with the machine learning training (or training “run”), etc.) based on the one or more metrics provided. If the user decides to proceed, and the method 400 receives an input at a user interface to proceed, then the machine-learning training is conducted at block 440.

As noted above, block 420 may be performed a first time to conduct a first analysis to determine a first set of metrics. In such a case, block 430 will comprise outputting an indication of the first set of metrics to the user interface prior to the conducting the machine-learning training in block 440 for the first time. However, once some machine-learning training is conducted and the method 400 returns to block 420 such that a subsequent analysis determines a subsequent set of metrics, it is understood that some machine-learning training has been conducted that that subsequent performance of the functionality of block 430 will be after having conducted some machine-learning training in a previous cycle illustrated by recursive arrow 450.

It can be noted that one or more additional analyses may be performed in the same manner after a portion of the machine-learning training is conducted. That is, as indicated by recursive arrow 450, the method 400 may return to the functionality performed at block 420 after at least a portion of the machine-learning training has been conducted. The second set of metrics can be used as feedback to indicate to a user the suitability of a remaining portion of the training data (which may give the user an opportunity to change the controls of the machine-learning training parameters and/or upload additional images to be used as training data). Additionally or alternatively, the training algorithm may automatically modify the training process based on the second set of metrics, adjusting one or more machine-learning parameters based at least in part on the set of metrics. In other words, a second (or subsequent) analysis may be performed after conducting at least a portion of the machine-learning training by conducting a new analysis of a remaining portion of set of training data (e.g., image samples) to determine a new set of metrics indicative of the suitability of the remaining portion of the set of training data for continuing the machine learning training for object recognition. One or more machine-learning parameters can then be adjusted (e.g., automatically or based on user input received at a user interface) prior to continuing conducting the machine-learning training.

Once the method 400 has conducted some machine-learning training, and has thereby generated an intermediate, not-fully-trained model, the new analysis performed during the paused training can include analysis not just of the remaining portion but can additionally or alternatively include analysis of the intermediate model. In such a case, a set of metrics indicating how well the machine-learning training is progressing can be determined. For example, for object detection using a classifier having a plurality of stages, such as a cascade classifier, in some implementations that the number of CV features used in each stage of the cascade classifier increases, such that in the first stage of the cascade classifier only a few CV features are used, and in the second stage a larger number of features are use, until the last stage where a relatively large number of features are used. Hence, in such an implementation, when machine-learning training at block 440 is conducted partially to generate an intermediate model having only an intermediate number of stages trained that is less than the total number of stages of the fully trained model, the analysis can include an analysis of a number of CV features used in each of the intermediate number of stages. If the number of CV features is increasing, generally, over the intermediate number of stages, this can indicate that the training is progressing and should continue. However, if the number of CV features at each is remaining the same across the stages, or not increasing as much as expected, then this may indicate that the machine-learning training is not progressing and that it may not be recommended to continue training and that better training data should be gathered to try training again later on the improved training data. As such, a metric in the set of metrics can include the number of CV features in each stage of an intermediate model. Additionally or alternatively, the metric in the set of metrics can include any combination of the number of CV features in each stage of the intermediate model, the size of the CV features in each stage of the intermediate model, the rejection rate of each stage of the intermediate model, the complexity of the features in each stage of the intermediate model, an indication of the progression of a parameter over each stage of the intermediate model, a histogram of parameters (such as a CV feature) for each stage of the intermediate model, a distribution of parameters (such as a CV feature) types or sizes for each stage of the intermediate model, or more generally, a parameter indicative of how well the training is progressing.

In another example of parameter(s) indicative of how well the training is progressing, the intermediate model may be used on a test set of data or a validation set of data that is extracted from the training data (i.e., where the test or validation set is a subset of the training data) which was not used during the partial machine-learning training. How well the intermediate model performs on the test or validation set will also give a sense of how well the training is progressing. As such, a metric that can be part of a second set of metrics can include a score indicative of the strength or weakness of positive detections within the test or validation set (i.e., a score related to detecting the object using the intermediate model on a known positive training image or images) and/or the strength or weakness of negative detections within the test or validation set (i.e., a score related to failing to detect the object using the intermediate model on a known negative training image or images). The second set of metrics may be output to a user interface, and user input can be received subsequent to outputting the second set of metrics, as discussed elsewhere herein.

With regard to user controls for adjusting settings of the machine-learning training process, because the user may not be an expert at machine-learning training, the user may be provided with simplified controls through a user interface enabling the user to provide basic input selections that can affect how the server adjusts various machine-learning parameters, such that the server can receive the user inputs from the user interface. For example, a user may be able to select between running a relatively fast training resulting in a relatively high error rate (low accuracy) of object detection by the trained model, running a relatively slow training with a relatively low error rate (high accuracy), and/or selecting from a sliding scale or series of selections reflecting speed and error rates (which can be related to accuracy) somewhere in between. High and low accuracy may also be defined in terms of a target true positive rate and/or a target false negative rate. More generally, a user may provide an input selection indicative of a desired speed of the machine-learning training, or a desired accuracy of object detection by the trained model generated by the machine-learning training, or any combination thereof. The input selection received from the user can be informed by the first or second set of metrics output to the user. Hence, in one example, where the first set of metrics includes a histogram of CV features within the provided training data set, the output indicative of the first set of metrics can include, by way of example, some indication of the number of CV features that occur greater than some threshold number of times, and hence, responsive to this, a user may indicate how many of that number of CV features the user would like to use in training. The greater the number of CV features to be used, the more accurate the model will be once trained, but also the longer the training will take. Additionally or alternatively, an input selection could include receiving by method 400 additional or different training data based on the indication of the first set of metrics or the second set of metrics that was output to the user interface. In such a case, the indication of the first or second set of metrics may inform the user that additional or different data would improve training, give the user some idea of what kind of additional or different data would be helpful, and then receive from the user additional new training data. Based on the new training data, in some implementations, one or more machine-learning parameters can be set as will be described further below.

In one implementation, after outputting the indication of the first set of metrics to the user interface, and prior to conducting the machine-learning training, the method 400 may receive an indication of an input selection from a user interface. In another implementation, after outputting an indication of the second set of metrics to the user interface, and prior to continuing conducting the machine-learning training, the method 400 may receive an indication of an input selection from the user interface. In such an implementation where the machine-learning has been paused, the user may choose, for example, to change speed and/or accuracy selection made before the training started after having seen the outputted indication of the second set of metrics, and as such, an input selection received prior to any machine-learning training being conducted can be different from an input selection received after some machine-learning training was conducted. The server may then set one or more machine-learning parameters for the machine-learning training that are reflective of the user selection, such determining whether to use what subset of CV features to use, and/or other image processing techniques, and/or what threshold(s) or parameters to use in the selected technique(s). As such, in one implementation, setting the one or more machine-learning parameters based on the input selection can include determining a set of CV features to be used in the machine-learning training. For example, for a certain type of object detection, a certain CV feature (including the type of CV feature and/or the threshold level for the type of CV feature) or set of certain CV features may be useful in achieving a high accuracy. Hence, based on the input selection indicating that a high accuracy is desired, setting the one or more machine-learning parameters includes determining to use that certain CV feature or set of certain CV features and/or determining the threshold(s) for that certain CV feature or set of certain CV features. Other CV features may allow for faster training, and hence, based on the input selection indicating that faster training is desired, setting the one or more machine-learning parameters includes determining to use the other CV features and/or determining the threshold(s) for the other CV features. Additionally or alternatively, where a user selection can include the uploading of new training data, analysis of the new training data may indicate that a given set of CV features better distinguishes positives from negatives, and hence setting the one or more machine-learning parameters comprises determining the given set of CV features and/or determining the threshold(s) for the given set of CV features to be used in the machine-learning training. More generally, a set of CV features may be determined based on the input selection, where determining the set of CV features comprises a determination to use local binary pattern (LBP), a determination of an LBP threshold, a determination to use local ternary pattern (LTP), a determination of an LTP threshold, a determination to use LTP upper (LTP-U), a determination of an LTP-U threshold, a determination to use LTP lower (LTP-L), a determination of an LTP-L threshold, or any combination thereof.

Depending on the desired functionality, conducting the machine-learning trainings may comprise performing any of a variety of machine-learning training techniques. As previously discussed, one such technique comprises creating a cascade (or other) classifier, which may involve multiple stages of training during a training run. In some embodiments, after the completion of each stage, an additional analysis of the training data may be performed to determine its effectiveness, and metrics (including any of a variety of types of training metadata) may be used to indicate the results of the analysis to the user, enabling an inexperienced (non-expert) user to be guided through a relatively efficient process of training the model (creating the classifier). Because the analysis can take into account the training results thus far, the resultant metrics may provide information regarding the training that wasn't available prior to the training.

The rate of negative samples rejection is one example of such training metadata. Here, at each stage of a training run, the set of training data includes positive and negative image samples. The rate of rejection measures the average number of samples needed to be checked before a negative sample is rejected. For instance, a machine-learning training run may start with a pool of 10,000 negative image samples, using 1,000 negative samples at each stage of the training run. The machine-learning parameters for the training run may be set such that most (e.g., 99.9%) positive images are accepted, but only 50% of the negative images are rejected. Thus, after the an initial stage, only up to 500 of the initial 1,000 negative samples remain for use in the next stage and an additional 500 negative samples or more are selected from the pool of 10,000 negative images (constituting a set of 1,000 negative image samples to be used for the subsequent stage of training). Problematically, however, not all of the newly-selected images can be used at the next stage because some of these images will be rejected by the filters created in the prior stage(s). Hence, the rate of rejection measures the probability that the remaining negative samples in the pool end up being successfully selected for a particular training stage. This rate of rejection can be used as a metric for user and/or system feedback, providing a measure of the effectiveness of the remaining images for this training run. In some instances, it may indicate that the remaining training data may no longer be effective or unusable (if, for example, the rate of rejection reaches beyond a threshold level).

Because a large portion of the negative image samples may be rejected at different stages during the training run, and because negative image samples rejected at a certain stage in the training run cannot be effectively reused at a subsequent stage of the training, machine-learning training of a model (e.g., the creation of a cascade classifier) may exhaust the pool of negative image samples before training is complete. However, according to certain embodiments, after a portion of the training has been completed, an intermediate model may be used to help a user identify or collect new negative image samples for subsequent training.

FIG. 5 is a process flow diagram 500 illustrating a method of enabling the identification of negative samples for machine-learning training for object recognition, according to an embodiment, which uses an intermediate model. As with the method of FIG. 4, the functions illustrated in the blocks of FIG. 5 may be performed by a local computer 210 and/or remote server(s) 220, depending on desired functionality. Means for performing one or more of the blocks illustrated in FIG. 5 may include hardware and/or software components of a computer, such as the computer 700 of FIG. 7, which may function as a server remote from a local device of a user.

At block 510, a first portion of the machine-learning training is conducted using a first negative sample set. Here, the first negative sample set may comprise the initial pool of negative samples used at the beginning of the training run. It is understood that, more generally, the machine-learning training will be performed using training data, within which there will be negative samples and positive samples. The first portion of the machine-learning training will be performed only on a subset of the training data. In one example, the negative samples within the subset of the training data can comprise the first negative sample set. The first portion of the machine-learning training may comprise, for example, one or more stages in the creation of a cascade classifier, conducted before the initial pool of negative samples is exhausted. As previously indicated, the machine-learning training may be conducted by one or more computers in the “cloud” (e.g., server(s) 220 of FIG. 2) via a web portal accessed from a local device. According to some embodiments, the web portal may indicate, after a portion of the training run has been performed, that more negative image samples are needed to conduct further training. The determination that more negative image samples are needed may be made from a determined rate of negative image acceptance (e.g., when the rate of negative image acceptance falls below a particular threshold), as described above.

At block 520, an intermediate model may be created based at least in part on the first negative sample set. Here, for example, the intermediate model may comprise a cascade classifier having filters created in the training run thus far. As such, the intermediate model can be used to identify new negatives that may be useful for training. For example, because the intermediate model comprises filters created in the training process thus far, a user may provide prospective negative image samples to the intermediate model, which will reject negative image samples that would not be useful in further training and accept negative image samples that would be useful. Additionally or alternatively, the set of prospective negative images can be extracted from training data used to train the machine-learning model. In one example, training data received from the user will be used for machine-learning training. In the first portion of the machine-learning training, only a subset of the training data will be used. Once the intermediate model is generated, known negatives from the remainder of the training data (the rest of the training data that is not part of the subset used in training during the first portion) can be tested using the intermediate model. Known negatives (known images that do not contain the object to be detected by the trained model) that the intermediate model determines to be a positive are useful negatives that should be included in the second negative sample set discussed below. If a large number of the known negatives from the remainder of the training data are properly identified by the intermediate model as negative, then additional, more useful negatives should be found to be included in the second negative sample set. This is because the intermediate model is already capable of correctly classifying these known negatives as negative, and hence further training using these negatives will not improve negative rejection accuracy.

The intermediate model may be provided to the user in any of a variety of ways, depending on desired functionality. In some embodiments, for example, the intermediate model may be accessible to a user via a web interface (which may simply be a new window or other interface within the original web interface of the machine-learning training program) in which the user uploads prospective negative image samples. In some embodiments, the intermediate model may be provided to a user in the form of an application that, when executed by a computing device, enables the user to execute the model to analyze images provided by the user. In some embodiments, the model may be provided by software, firmware, or even hardware to the user.

Once the intermediate model is successfully used to identify a plurality of negative image samples for use in subsequent machine-learning training, the process can then proceed to block 530, which comprises obtaining a second negative image sample set comprising a plurality of negative image samples selected using the intermediate model on a set of prospective negative images. Here, the second negative sample set may comprise the plurality of negative image samples identified for use in the subsequent machine-learning training. As previously mentioned, this may be obtained by a server, for example, via a web interface or application enabling the uploading of the second negative sample set. In some embodiments, the second negative sample set (as with other sample sets described herein) may include videos and/or images from video, including, in some implementations, live-captured videos captured and provided by a user. Obtaining the set of prospective negative images can comprise extracting the prospective negative images from training data used in the first or second portions of the machine-learning training, receiving images uploaded by the user, receiving images from a location on the Internet specified by the user, receiving images from a video file, or receiving images from a live video feed, or any combination thereof.

It can be noted that the negative image sample set (and/or other negative and/or positive image samples described elsewhere herein) may comprise one or more videos. Moreover, an application or web interface may further allow a user to annotate a portion of the area of an image as being positive or negative (that is, having or not having the object type in the portion of the image)

In some embodiments, a user may be able to select new images to provide to the intermediate model using the application, web portal, or other mechanism provided for machine-learning training. For example, some embodiments may allow a user to browse images (e.g., stored in an online database) to be used as positive or negative image samples. Where images are being hosted by a server, this may therefore comprise receiving a user input data server indicative of a type of object for object recognition, then sending from the server a plurality of images based on the user input.

In some embodiments, a questionnaire may be provided to the customer to help the customer search for relevant images. Here, to preserve the privacy of the data used by the customer, the questionnaire may be limited to broad questions. For example, the questionnaire may be limited to asking the user if the object type for identification belongs to a broad category such as an animal, where the user is seeking to train the model to identify dogs. Thus, the identity of the type of animal is still unknown. However, the entity hosting the images may use answers to the questionnaire to modify the selection of available images and to determine a demand or trend in the types of images used, which can better enable the entity hosting the images to cater to the needs of users.

In some embodiments, a portion of the images of the second negative sample set may be obtained from positive samples that were rejected during the first portion of the machine-learning training. The positive samples that were rejected may typically be a very small percentage of positive samples. During the machine-learning training, the model being trained can continue learning the CV features that distinguish negative samples from positive samples until most of the positive samples are correctly filtered from the negative samples. To continue learning to be able to correctly filter all positive samples form the negative samples may result in a model solution that does not converge. Hence, a target true positive rate is defined, for example, 95% or higher, but less than 100%, and once the true positive rate is reached, a given stage is considered to be trained. The few remaining positives that were not filtered from the negative samples can be considered as positive samples that were rejected by the machine-learning training. In many cases, these positive samples that were rejected do actually contain the object to be detected, in which case, such positive samples should remain within a second positive sample set to be used during the second portion of the machine-learning training. But in some other cases, these positive samples are actually incorrectly categorized as a positive sample in the training data, and as such, these images should be removed from the positive sample set, and may optionally be used as a negative sample in the second negative sample set. That is, according to embodiments, conducting the first portion of the machine-learning training in block 510 may further comprise using a positive sample set, and the method of FIG. 5 can further comprise determining that an image from the positive sample set was rejected during the first portion of the machine-learning training, and providing the image to the intermediate model to determine whether to include the image.

That said, a positive sample that was rejected during the first portion of the machine-learning training may, in fact, be a positive sample that was incorrectly rejected. Thus, embodiments may provide additional functionality to help confirm whether or not the rejected positive sample is actually a negative sample. In some embodiments, for example, the method may further comprise outputting the image to a user interface, and receiving user input indicating that the image is a negative sample or receiving user input indicating that the image is a positive sample. Once confirmed as a negative, In some embodiments, the method may further comprise analyzing (with a computer), one or more features of rejected positives to determine outliers, then including the outliers with the negatives or including them in a set of potential negatives to be confirmed by a user. Identifying outliers may comprise, for example, running a principal component analysis (PCA) on the rejected positives to determine the features that are most representative, then determining which positives (e.g. above a threshold) that have the fewest similarities to those representative features.

Additionally or alternatively, in some implementations, negative samples to be included in the second negative sample set can be extracted from positive samples, even if not rejected during machine-learning training. In one example, such negative samples can be generated by identifying the object to be identified using the intermediate model. Once an object is identified, a bounding box around the identified object can be defined. Areas in the image that do not include the object to be identified, for example, areas in the image outside of the bounding box, can now be used as negative samples. Alternatively, a negative sample could be generated by removing the bounding box from the image, and filling the area of the bounding box with a filler image or some artificial background image. Optionally, these generated negative samples can be output to a user interface to allow a user to confirm that the object to be detected is not within the image, and the confirmation can be received via the user interface.

Finally, at block 540, a second portion of the machine-learning training is conducted using the second negative sample set. Because the second negative sample set is selected using the intermediate model, the training process can proceed knowing that images in the second negative sample said will be useful in subsequent training.

It can be noted that the intermediate model created at block 520 may be included in the model that is subsequently trained and ultimately completed. For example, training a 12-stage cascade classifier according to the method illustrated in FIG. 5 may involve conducting a portion of the machine learning training to train the first 11 stages, then using the incomplete 11-stage cascade classifier for both the selection of the negative sample set to train the final stage and for subsequent training. Thus, the first 11 stages of the completed 12-stage cascade classifier may be identical to the incomplete 11-stage cascade classifier used as the “intermediate” model for negative sample selection. More broadly, the intermediate model used for negative sample selection at block 530 may comprise a “n−1” model that is incorporated into a final “n” model, where the “n−1” model represents at least a portion of the “n” model at some previous stage or previous point in time.

When the training of the model is complete or nearing completion, the application, web portal, or other machine-learning training mechanism can provide the user with an opportunity to continue training the model, purchase the model, or simply stop the training. It may also allow users to test the model to determine whether its performance is acceptable. Thus, the user can make an informed decision about the effectiveness of the trained model in object recognition before purchasing the model (e.g. for use in an end-user device).

FIG. 6 is a process flow diagram 600 illustrating a method of providing a trained model, according to an embodiment. Again, the functions illustrated in the blocks of FIG. 6 may be performed by a local computer 210 and/or remote server(s) 220, depending on desired functionality. Means for performing one or more of the blocks illustrated in FIG. 6 may include hardware and/or software components of a computer, such as the computer 700 of FIG. 7, which may function as a server remote from a local device of a user. It can be noted that some embodiments may include performing the method of FIG. 6 in addition to the method of FIG. 4 and/or the method of FIG. 5.

At block 610, machine-learning training is conducted to enable a trained model to recognize a type of object, where the machine-learning training uses a plurality of images obtained from a user. This functionality can generally follow the embodiments described above for conducting machine-learning training, allowing a user to provide images for machine-learning training of a model. For example, in one implementation, conducting machine-learning at block 610 includes conducting the machine-learning training with reference to block 440 of FIG. 4 and/or conducting a first portion of machine-learning training and second portion of the machine-learning training with reference to blocks 510 and 540 of FIG. 5.

At block 620, an indication of an ability of the trained model to recognize the type of object is provided. Here, the indication can be provided in any of a variety of ways to help the user determine whether the trained model is satisfactory. For example, the indication may be to provide a “test” model in a manner similar to the intermediate model described in FIG. 4 (e.g., via a web interface, application, etc.), allowing a user to use the model on a variety of image samples to determine the model's effectiveness at object recognition. In some embodiments, the computer implementing the functionality of block 620 may provide the indication of the ability of the trained model to recognize the type of object by using the model to detect the type of object in one or more images and providing the results of the use to the user. To help ensure that the user pays for the trained model (rather than simply using the test model) the test model may have a reduced functionality (e.g., operate at a reduced frame rate), have a time lock or other means by which the model expires after a certain period of time, and/or include other limitations that may be sufficient to satisfy the user of the effectiveness of the trained model but ultimately undesirable for long-term use.

At block 630, and subsequent to providing the indication, a user input indicative of an acceptance of the trained model is received. Here, the user may provide an input to the application or web portal in which the model was trained to indicate that the user is satisfied with and/or would like to purchase the trained model. In this case, the model can then be provided to the user at block 640. Here, “providing” the model can include taking steps to allow the user to use the trained model, such as transmit the model from the server on which the model was trained (e.g., server(s) 220 of FIG. 2) to the local device (e.g., local computer 210). (The model may then be transferred to the ultimate devices on which object detection is to be performed, by, for example, programming these devices in accordance with the trained model.) In some implementations, the trained model may be provided on a “model as a service” basis. As such, use of the model training software, whether on a local device, in the cloud, or a combination of both, may be provided for free or for some fee. However, according to some embodiments, the fully functional model may be additionally provided or transmitted in a form for use in the ultimate devices responsive to receipt of payment from the user, an agreement to an obligation of payment by the user. Alternatively, other purchases and/or licenses may be utilized such that a receipt of payment or an obligation of payment may not be needed prior to providing/transmitting the fully-functional model.

It can be noted that, because the embodiments described herein may be implemented by non-experts, conducting machine-learning training of a model either locally or in the cloud, the privacy of the user's data used in training the model is protected. As indicated elsewhere herein, a provider of the machine-learning training service may receive information regarding the metrics obtained from image data during the machine-learning training, which can allow the provider to modify its services and/or available images to make its services more efficient and accommodate the needs of its users. That said, because the techniques provided herein enable non-experts to train a model without the need of expert services, there is no need to share the image data with an expert (or other party) in the process.

FIG. 7 illustrates an embodiment of a computer system 700, which may be used, in whole or in part, to provide the machine-learning training discussed in the embodiments provided herein (e.g., as part of a local computer and/or “cloud” system, such as the system 200 illustrated in FIG. 2), and may therefore be incorporated into one or more devices described in the embodiments herein (e.g., server(s) 220, and user device(s) 105, image source(s) 240, and/or local computer 210). FIG. 7 provides a schematic illustration of one embodiment of a computer system 700 that can perform methods of the previously-described embodiments, such as the methods of FIGS. 4-6. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner. In addition, it can be noted that components illustrated by FIG. 7 can be localized to a single device and/or distributed among various networked devices, which may be disposed at different physical locations.

The computer system 700 is shown comprising hardware elements that can be electrically coupled via a bus 705 (or may otherwise be in communication, as appropriate). The hardware elements may include processing unit(s) 710, which may comprise without limitation one or more general-purpose processors, one or more special-purpose processors (such as digital signal processing chips, graphics acceleration processors, and/or the like), and/or other processing structure, which can be configured to perform one or more of the methods described herein. The processing unit(s) 710 can comprise, for example, means for performing the functionality of one or more of the blocks shown in FIGS. 4, 5, and/or 6. The computer system 700 also may comprise one or more input devices 715, which may comprise without limitation a mouse, a keyboard, a camera, a microphone, and/or the like; and one or more output devices 720, which may comprise without limitation a display device, a printer, and/or the like. The input devices 715 can comprise, for example, means for performing the functionality of one or more of block 410 with reference to FIG. 4, blocks 510 and 530 with reference to FIG. 5, and blocks 610 and 630 with reference to FIG. 6. The output devices 720 can comprise, for example, means for performing the functionality of one or more of block 430 with reference to FIG. 4 and block 630 with reference to FIG. 6.

The computer system 700 may further include (and/or be in communication with) one or more non-transitory storage devices 725, which can comprise, without limitation, local and/or network accessible storage, and/or may comprise, without limitation, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 700 might also include a communications subsystem 730, which may comprise wireless communication technologies managed and controlled by a wireless communication interface 733, as well as wired technologies (such as Ethernet, coaxial communications, universal serial bus (USB), and the like). As such, the communications subsystem may comprise a modem, a network card (wireless or wired), an infrared communication device, a wireless communication device, and/or a chipset (such as a Bluetooth device, an Institute of Electrical and Electronics Engineers (IEEE) 802.11 device, an IEEE 802.15.4 device, a WiFi device, a WiMax device, cellular communication facilities, ultra wide band (UWB) interface, etc.), and/or the like. The communications subsystem 730 may include one or more input and/or output communication interfaces, such as the wireless communication interface 733, to permit the computer system 700 to communicate with other computer systems and/or any other electronic devices described herein. Hence, the communications subsystem 730 may be used to receive and send data as described in the embodiments herein. The communications subsystem 730 can comprise, for example, mean for performing the functionality of blocks 410 and 430 with reference to FIG. 4, blocks 510 and 530 with reference to FIG. 5, and blocks 610, 620, 630, and 640 with reference to FIG. 6.

In many embodiments, the computer system 700 will further comprise a working memory 735, which may comprise a RAM or ROM device, as described above. Software elements, shown as being located within the working memory 735, may comprise an operating system 740, device drivers, executable libraries, and/or other code, such as one or more applications 745, which may comprise computer programs provided by various embodiments, and/or may be designed to implement methods, and/or configure systems, provided by other embodiments, as described herein. For example, application 745 can include a computer program for performing the functions described with reference to FIGS. 4, 5, and 6. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods, in particular, the methods of FIGS. 4, 5, and 6.

A set of these instructions and/or code might be stored on a non-transitory computer-readable storage medium, such as the storage device(s) 725 described above. In some cases, the storage medium might be incorporated within a computer system, such as computer system 700. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

With reference to the appended figures, components that may comprise memory may comprise non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media, volatile media, and transmission media. Common forms of computer-readable media include, for example, magnetic and/or optical media, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus, many of the elements are examples that do not limit the scope of the disclosure to those specific examples.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method of enabling identification of negative samples for machine-learning training for object recognition, the method comprising:
conducting a first portion of the machine-learning training, wherein the conducting the first portion of the machine-learning training comprises using a first negative sample set;
creating an intermediate model, based at least in part on the first negative sample set;
obtaining a second negative sample set comprising a plurality of negative samples selected using the intermediate model on a set of prospective negative images; and
conducting a second portion of the machine-learning training, wherein the second portion of the machine-learning training comprises using the second negative sample set.

2. The method of claim 1, further comprising conducting the second portion of the machine-learning training such that a resulting trained model includes the intermediate model.

3. The method of claim 1, wherein conducting the first portion of the machine-learning training also comprises using a positive sample set, the method further comprising:
determining that at an image from the positive sample set was rejected during the first portion of the machine-learning training; and
providing the image to the intermediate model to determine whether to include the image in the second negative sample set.

4. The method of claim 3, further comprising:
providing the image to a user; and
receiving user input indicating that the image is a negative sample.

5. The method of claim 1, further comprising:
receiving, at a server, a user input indicative of a type of object for object recognition; and
sending, from the server, a plurality of images based on the user input.

6. The method of claim 1, wherein obtaining the set of prospective negative images comprises:
receiving images uploaded by a user,
receiving images from a location on the Internet specified by a user,
receiving images from a video file, or
receiving images from a live video feed, or
any combination thereof.

7. The method of claim 6, wherein obtaining the second negative sample set comprises receiving, at a server via a data connection, the set of prospective negative images.

8. The method of claim 1 further comprising:
obtaining a trained model based, at least in part, on the first portion and the second portion of the machine-learning training;
providing an indication of an ability of the trained model to recognize a type of object;
subsequent to providing the indication, receiving a user input indicative of an acceptance of the trained model; and
providing the trained model to the user.

9. The method of claim 8, wherein providing the indication of the ability of the trained model to recognize the type of object comprises using the trained model to detect the type of object in an image.

10. The method of claim 8, wherein providing the indication of the ability of the trained model to recognize the type of object comprises providing the user with a test model based on the trained model and configured to expire after a certain period of time.

11. The method of claim 8, wherein providing the indication of the ability of the trained model to recognize the type of object comprises providing the user with a test model based on the trained model and having reduced functionality compared with the trained model.

12. The method of claim 8, wherein providing the trained model to the user comprises transmitting the trained model from a server to a user device.

13. The method of claim 8, wherein the providing the trained model to the user is responsive to receipt of payment from the user or receipt of an agreement to an obligation of payment from the user.

14. A computer comprising:
a memory; and
a processing unit communicatively coupled with the memory and configured to cause the computer to:
conduct a first portion of machine-learning training, wherein conducting the first portion of the machine-learning training comprises using a first negative sample set;
create an intermediate model, based at least in part on the first negative sample set;
obtain a second negative sample set comprising a plurality of negative samples selected using the intermediate model on a set of prospective negative images; and
conduct a second portion of the machine-learning training, wherein the second portion of the machine-learning training comprises using the second negative sample set.

15. The computer of claim 14, wherein the processing unit is further configured to cause the computer to conduct the second portion of the machine-learning training such that a resulting trained model includes the intermediate model.

16. The computer of claim 14, wherein the processing unit is further configured to cause the computer to:
conduct the first portion of the machine-learning training by using a positive sample set,
determine that at an image from the positive sample set was rejected during the first portion of the machine-learning training; and
provide the image to the intermediate model to determine whether to include the image in the second negative sample set.

17. The computer of claim 16, wherein the processing unit is further configured to cause the computer to:
provide the image to a user; and
receive user input indicating that the image is a negative sample.

18. The computer of claim 14, wherein the processing unit is further configured to cause the computer to:
receive a user input indicative of a type of object for object recognition; and
send a plurality of images based on the user input.

19. The computer of claim 14, wherein the processing unit is configured to cause the computer to obtain the set of prospective negative images by:
receiving images uploaded by a user,
receiving images from a location on the Internet specified by a user,
receiving images from a video file, or
receiving images from a live video feed, or
any combination thereof.

20. The computer of claim 19, wherein the processing unit is configured to cause the computer to obtain the second negative sample set by receiving, at a server via a data connection, the set of prospective negative images.

21. The computer of claim 14 wherein the processing unit is further configured to cause the computer to:
obtain a trained model based, at least in part, on the first portion and the second portion of the machine-learning training;
provide an indication of an ability of the trained model to recognize a type of object;
receive, subsequent to providing the indication, a user input indicative of an acceptance of the trained model; and
provide the trained model to the user.

22. The computer of claim 21, wherein the processing unit is configured to cause the computer to provide the indication of the ability of the trained model to recognize the type of object by using the trained model to detect the type of object in an image.

23. The computer of claim 21, wherein the processing unit is configured to cause the computer to provide the indication of the ability of the trained model to recognize the type of object by providing the user with a test model based on the trained model and configured to expire after a certain period of time.

24. The computer of claim 21, wherein the processing unit is configured to cause the computer to provide the indication of the ability of the trained model to recognize the type of object by providing the user with a test model based on the trained model and having reduced functionality compared with the trained model.

25. The computer of claim 21, wherein the processing unit is configured to cause the computer to provide the trained model to the user by transmitting the trained model from a server to a user device.

26. The computer of claim 21, wherein the processing unit is configured to cause the computer to provide the trained model to the user in response to receipt of payment from the user or receipt of an agreement to an obligation of payment from the user.

27. A system comprising:
means for conducting a first portion of machine-learning training, wherein the conducting the first portion of the machine-learning training comprises using a first negative sample set;
means for creating an intermediate model, based at least in part on the first negative sample set;
means for obtaining a second negative sample set comprising a plurality of negative samples selected using the intermediate model on a set of prospective negative images; and
means for conducting a second portion of the machine-learning training, wherein the second portion of the machine-learning training comprises using the second negative sample set.

28. The system of claim 27, further comprising means for conducting the second portion of the machine-learning training such that a resulting trained model includes the intermediate model.

29. The system of claim 27, further comprising:
means for receiving a user input indicative of a type of object for object recognition; and
means for sending a plurality of images based on the user input.

30. A non-transitory computer-readable medium having instructions embedded thereon for enabling identification of negative samples for machine-learning training for object recognition, wherein the instructions, when executed by one or more computer systems, cause the one or more computer systems to:
conduct a first portion of the machine-learning training, wherein conducting the first portion of the machine-learning training comprises using a first negative sample set;
create an intermediate model, based at least in part on the first negative sample set;
obtain a second negative sample set comprising a plurality of negative samples selected using the intermediate model on a set of prospective negative images; and
conduct a second portion of the machine-learning training, wherein the second portion of the machine-learning training comprises using the second negative sample set.
